(19) United States
(12) Patent Application Publication
(10) Pub. No.: US 2025/0325931 A1
(43) Pub. Date: Oct. 23, 2025

(54) SWIRL FLOW GENERATOR AND VORTEX FINDER FOR SEPARATING PHASES OF MATERIAL

(71) Applicant: Khalifa University of Science and Technology, Abu Dhabi (AE)

(72) Inventors: Nabil Kharoua, Abu Dhabi (AE); Mahmoud Meribout, Abu Dhabi (AE); Lyes Khezzar, Abu Dhabi (AE)

(21) Appl. No.: 19/180,606

(22) Filed: Apr. 16, 2025

Related U.S. Application Data
(60) Provisional application No. 63/637,861, filed on Apr. 23, 2024.

(51) Int. Cl. B01D 45/16; B04C 3/00; B04C 3/06

(52) U.S. Cl. CPC B01D 45/16; B04C 3/06; B04C 2003/006

(57) ABSTRACT

A system can be used to separate input material into different phases. The system can include a swirl flow generator and a tubular housing. The swirl flow generator can include an inlet channel that can be oriented in a first direction to receive input material that can include a set of phases and to accelerate the input material in approximately a centripetal direction. The tubular housing can be coupled with the swirl flow generator to receive the input material from the swirl flow generator, and the tubular housing can be oriented in a second direction that is different than the first direction. The tubular housing can include a vortex finder that can be positioned along a length of the tubular housing and configured to separate the set of phases into separated phases.

### CROSS-REFERENCES TO RELATED APPLICATIONS

This application claims the benefit of U.S. Provisional Patent Application No. 63/637,861, filed Apr. 23, 2024, the entire contents of which are hereby incorporated by reference for all purposes in its entirety.

### BACKGROUND OF THE INVENTION

Various materials that can be used in a wide array of industries can include more than one phase. For example, the various materials can be or include a multi-phase material that can include multiple phases such as one or more gasses, one or more liquids, or any combination thereof. The multiple phases may differ in weight, density, and the like. Separating the multiple phases efficiently and without the need for expensive, complicated, or delicate equipment can be difficult.

### BRIEF SUMMARY OF THE INVENTION

In certain embodiments, a system can be used to separate an input material into separate phases. The system can include a swirl flow generator and a tubular housing. The swirl flow generator can include an inlet channel that can be oriented in a first direction to receive input material that includes a set of phases and to accelerate the input material in approximately a centripetal direction. The tubular housing can be coupled with the swirl flow generator to receive the input material from the swirl flow generator. The tubular housing can be oriented in a second direction that is different than the first direction, and the tubular housing can include a vortex finder that can be positioned along a length of the tubular housing and that can be configured to separate the set of phases into separated phases.

In other embodiments, a system can be used to separate an input material into separate phases. The system can include a tubular housing and a vortex finder. The tubular housing can define a flow channel that can be configured for receiving input material that originates from a swirl flow generator and that can include a set of phases. The tubular housing can be coupled with the swirl flow generator. The vortex finder can include an inner channel and a tapered region. The vortex finder can be positioned along a length of the tubular housing to define an annular channel between an outer surface of a body of the vortex finder and an inner wall of the tubular housing and to separate the set of phases into separated phases via the inner channel and the annular channel.

In yet other embodiments, a system can be used to separate an input material into separate phases. The system can include a swirl flow generator that can include an inlet channel and a swirl chamber. The inlet channel can be oriented in a first direction to receive input material that can include a set of phases. The swirl chamber can be coupled with the inlet channel to receive the set of phases and to accelerate the input material in approximately a centripetal direction and toward a tubular housing that can be oriented in a second direction that is different than the first direction. The tubular housing can include a vortex finder that can be used to separate the set of phases into separated phases.

### BRIEF DESCRIPTION OF THE DRAWINGS

FIG. 1 is a perspective view of a system including a swirl flow generator and a tubular housing having a vortex finder for separating phases of an input material according to certain aspects of the present disclosure.

FIG. 2 is a side view of a system including a swirl flow generator and a tubular housing having a vortex finder for separating phases of an input material according to certain aspects of the present disclosure.

FIG. 3 is a zoomed-in side view of a system including a swirl flow generator and a tubular housing having a vortex finder for separating phases of an input material according to certain aspects of the present disclosure.

FIG. 4 is a flowchart of a process to separate phases of an input using a system including a swirl flow generator and a tubular housing having a vortex finder according to certain aspects of the present disclosure.

### DETAILED DESCRIPTION OF THE INVENTION

Certain aspects and features of the present disclosure relate to a system, such as a centrifugal separator or other suitable type of separator, that can be used to separate input material into a set of separated phases. The input material may include one or more gas-phase materials, one or more liquid-phase materials, or any combination thereof. The system can include a swirl flow generator, a tubular housing, and the like to separate the phases included in the input material. The swirl flow generator may be configured to receive and accelerate the input material in approximately a centripetal direction, and the tubular housing may receive the accelerated input material and may use a vortex finder to separate the input material into the separated phases, to extract and/or collect the separated phases, or the like. The vortex finder may separate the input material using an annulus and a central path defined by a position of the vortex finder in the tubular housing.

A separator, such as a centrifugal separator, may be operated based on conversion of a translational flow into a swirling flow based on a geometrical design of a swirl flow generator to separate input material into separated phases. The input material may include a light phase, such as a gas phase or a light liquid phase, and a heavy phase such as a liquid phase or a heavy liquid phase. The swirl flow generator can include a tangential inlet connected to a pipe or guiding vanes. The light phase can agglomerate within the core region while the heavy phase can be ejected towards the pipe wall. Once separated, the phases can be collected at different outlets such as a central outlet, an annular outlet, etc. The design of the outlets may influence a separation efficiency. The light phase can be collected through a central channel of a vortex finder placed on the opposite side of the outlets, and the central channel may be coupled with, or otherwise be arranged to convey the light phase to, the central outlet. The vortex finder can additionally define an annulus that can be used to collect the heavy phase such as via an annular outlet. The swirling flow characteristics can be controlled by the swirl flow generator acting as a flow conditioner. For example, the swirling flow characteristics may produce different portions or regions within the flow, such as a bluff body, and the shape of the bluff body can dictate the way the separation is accomplished and its efficiency. In some examples, a given phase may attempt to migrate toward an incorrect outlet, but this can be prevented by adjusting a back-pressure downstream of the two outlets using valves.

In a centrifugal separator, which may be configured to perform gas-liquid separation and/or liquid-liquid separation, a cylindrical vortex finder can be used to collect a lighter phase included in input material to the centrifugal separator. For example, the cylindrical vortex finder may be used to separate, and collect, the gas phase from the liquid phase or the light liquid phase from the heavy liquid phase. However, a pure cylindrical shape may not yield an efficient separation since the liquid phase, or the heavy liquid phase, can be entrained. The cylindrical vortex finder may be adjusted with complex additional auxiliaries, such as channels or plates, to prevent the liquid, or heavy liquid, phase from approaching the gas, or light liquid outlet. However, the complex additional auxiliaries may not be reliable and may be resource-intensive.

A modification or adjustment to the cylindrical vortex finder can be made to enhance a performance of separating phases of an input material. For example, a system for separating the input material can include a vortex finder having a tapered region on one end of the vortex finder to prevent or mitigate the liquid or heavy phase, which is extracted via an annulus, migrating toward a central channel of the vortex finder. Additionally or alternatively, the tapered region can prevent an air core, or the gas or light phase of the input material, from migrating toward annular space due to back-pressure generated by the liquid or heavy phase.

The system for separating the input material into separate phases can include a swirl flow generator and a tubular housing that can include the vortex finder. The input material may include a lighter phase, such as a gas phase or a light liquid phase, and a heavier phase such as a liquid or heavy liquid phase. The swirl flow generator can generate a swirling flow driving the heavier phase of the input material towards a first outlet and the lighter phase toward a second outlet. The heavier phase and the lighter phase (collectively referred to hereinafter as “the phases”) can be collected via the vortex finder (for example via a central channel of the vortex finder) and/or an annulus defined between an outer surface of the vortex finder and an inner surface of the tubular housing. One or more valves can be provided at both outlets, as well as at an inlet of the swirl flow generator, to adjust individual flows of the phases to maximize separation between the phases.

The system can be used for production, multiphase flow metering, and other suitable use cases or industries. For instance, the system can be used in power generation, environmental engineering, electronics production, food and chemical production or processing, and the like. The system can involve or otherwise yield a reduced footprint compared to gravity separators, which can make the system suitable for compact installations. Additionally or alternatively, several measurement techniques, such as for multiphase flows, can be based on in-line separation to produce two bulk streams, which can be handled by precise single or two-phase flow measurement instruments, and the system can use in-line separation to generate the two bulk streams.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

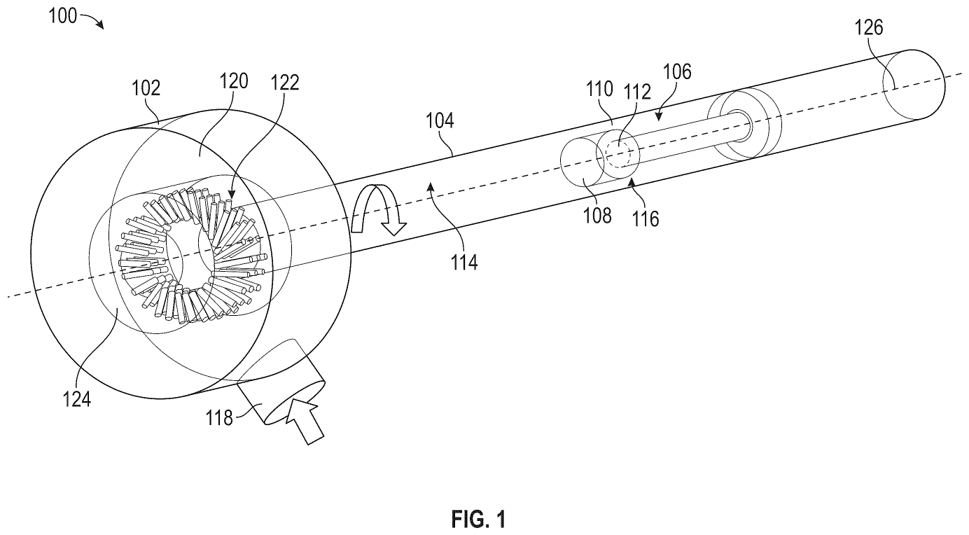

FIG. 1 is a perspective view of a system 100 that includes a swirl flow generator 102 and a tubular housing 104 that includes a vortex finder 106 for separating phases of an input material according to certain aspects of the present disclosure. In some examples, the system 100 may be or include a centrifugal separator or other suitable separator that can be used to separate the input material into separated phases that can include a light phase and a heavy phase. The input material may include one or more gas phases or materials, one or more liquid phases or materials, or any combination thereof. For example, the input material may include a gas phase and a liquid phase, may include a lighter liquid phase and a heavier liquid phase, and the like. The light phase may include the gas phase and/or the lighter liquid phase, and the heavy phase may include the liquid phase or the heavier liquid phase. Some examples of the light phase can include methane, nitrogen, atmospheric air, water, and the like. Some examples of the heavy phase can include oil, water, and the like.

The swirl flow generator 102 can be coupled with the tubular housing 104, and the vortex finder 106 can be included with, such as positioned within, contained in, or otherwise located inside, the tubular housing 104. For example, the vortex finder 106 can be positioned concentrically within the tubular housing 104 and/or otherwise such that the vortex finder 106 defines a central channel 108 and an annulus 110. The central channel 108 may extend through a central portion of the vortex finder 106 and/or the tubular housing 104. The annulus 110 may extend radially from an outer surface 112 of the vortex finder 106 to an inner surface 114 of the tubular housing 104. In some examples, the vortex finder 106 may be positioned along a length of the tubular housing 104 to optimize a separation efficiency of the system 100. For example, the vortex finder 106 may be positioned at a location 116 along the length of the tubular housing 104 to optimize, such as maximize, the separation efficiency of the system 100.

The system 100 may receive input material and collect or otherwise generate separated phases from the input material. The system 100 may receive the input material via an inlet 118 of the swirl flow generator 102. The system 100 can receive the input material as a stream, such as a continuous stream, a pulsed stream, and the like, and the input material can be accelerated in approximately a centripetal direction to cause the input material to undergo swirl motion. As used herein, the term approximately means that the recited value can range from about 1%, about 2%, about 3%, about 4%, about 5-10%, or about 10-20% above or below the recited value.

In some examples, the input material can pass through the inlet 118 and into an annular chamber 120 of the swirl flow generator 102. The annular chamber 120 may form an annulus between outer portions and inner portions of the swirl flow generator 102. For example, the annular chamber 120 may form the annulus between an inner surface of an outer housing of the swirl flow generator 102 and an outer surface of an internal chamber, such as an internal cylindrical chamber 124, of the swirl flow generator 102. From the annular chamber 120, the input material can then pass through a series of incline holes, such as tangential inlets 122, to the internal cylindrical chamber 124 that can cause the input material to undergo the swirl motion and to be released into the tubular housing 104. A centrifugal force F can eject the heavy phase toward the annulus 110, while the light phase can agglomerate within the central channel 108. In some examples, the centrifugal force can be F=mω²r in which m is the mass of the input material, or components thereof, ω is the tangential velocity component of the input material, or components thereof, and r is a distance from an axis 126 extending along a central path of the tubular housing 104. The heavy phase can be collected from the annulus 110, and the light phase can be collected from the central channel 108. In some examples, only the heavy phase may be directed to and/or collected via the annulus 110, and only the light phase may be directed to and/or collected via the central channel 108.

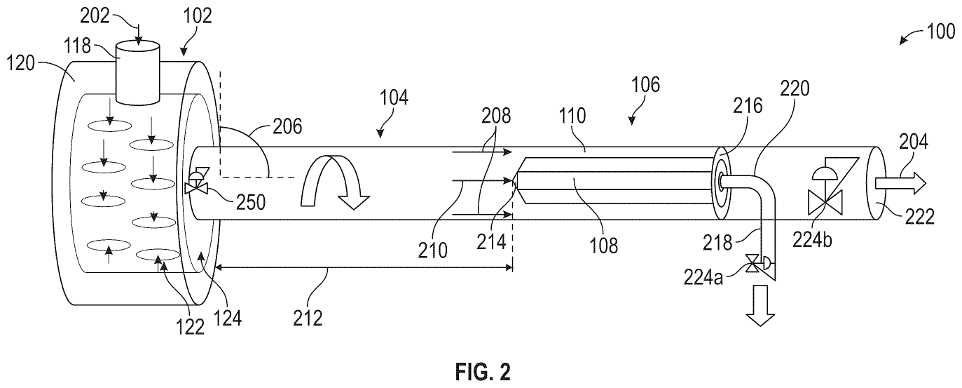

FIG. 2 is a side view of a system 100 including a swirl flow generator 102 and a tubular housing 104 having a vortex finder 106 for separating phases of an input material according to certain aspects of the present disclosure. In some examples, the system 100 may be similar or identical to the system 100 illustrated and described with respect to FIG. 1. For example, the swirl flow generator 102 may be coupled with the tubular housing 104, and the vortex finder 106 may be positioned within the tubular housing 104, and so on. As illustrated in FIG. 2, the swirl flow generator 102 and the tubular housing 104 may be coupled such that the inlet 118 may be oriented in a first direction 202, and the tubular housing 104 may be oriented in a second direction 204. The first direction 202 may be at an angle 206 with the second direction 204. The angle 206 may be approximately perpendicular or approximately non-perpendicular. For example, the angle 206 may be approximately a right angle, may be from approximately 0° to approximately 180°, may be approximately 80°, may be approximately 100°, or other angle. The angle 206 may be selected to enhance a stability of the centrifugal flow of material through the tubular housing 104. For example, the tubular housing 104 may be positioned at the angle 206 to extend a length of stable separation along the length of the tubular housing 206, to enhance a separation efficiency of the system 100 for separating the light phase from the heavy phase, and the like.

The swirl flow generator 102 may receive the input material via the inlet 118. The input material can progressively pass through the inlet 118, into the annular chamber 120, via the tangential inlets 122, and into the internal cylindrical chamber 124. The internal cylindrical chamber 124 can cause the input material to undergo the swirl motion and to be released into the tubular housing 104 based on the centrifugal force F that can eject a heavy phase 208 toward the annulus 110, while a light phase 210 can agglomerate within the central channel 108. The heavy phase 208 can include heavier compounds, such as liquid or heavy liquids, of the input material, and the light phase 210 can include lighter compounds, such as gas or light liquids, of the input material.

In some examples, and under given flow conditions, the light phase 210 can be stable along a stable axial length 212, which can be predetermined based on a composition of the input material, the angle 206, and other suitable parameters of the system 100. The tubular housing 104 can extend beyond the stable axial length 212, for example to allow the vortex finder 106 to be positioned within the tubular housing 104. The vortex finder 106 can be positioned inside the tubular housing 104 such that a front end 214 of the vortex finder 106 is positioned at or otherwise within the stable axial length 212.

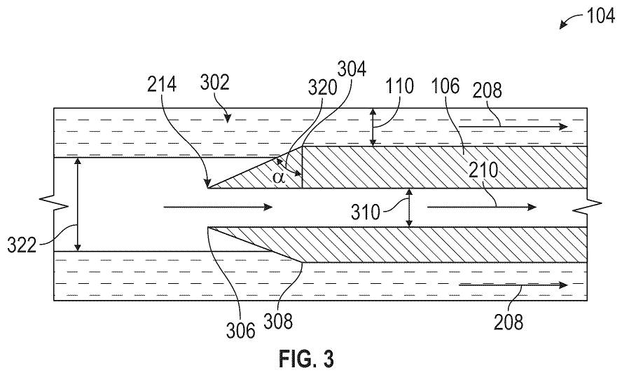

Referring briefly to FIG. 3, FIG. 3 is a zoomed-in side view of a system 100 including the swirl flow generator 102 and the tubular housing 104 having the vortex finder 106 for separating phases of an input material according to certain aspects of the present disclosure. The vortex finder 106 can have a tapered region 302 that extends from the front end 214 to a point 304 along a body of the vortex finder 106. For example, the vortex finder 106 can have an outer diameter that can increase from a first diameter 306 to a second diameter 308 along or otherwise within the tapered region 302. The first diameter 306 can be positioned at the front end 214 of the vortex finder 106. The second diameter 308 may be sized to define the annulus 110 and to receive a first phase, such as the heavy phase 208, of the input material. Additionally or alternatively, the vortex finder 106 can have an inner diameter 310 that can define the central channel 108. The inner diameter 310 can be sized to receive a second phase, such as the light phase 210, of the input material.

Referring back to FIG. 2, the vortex finder 106 can be configured to maximize or otherwise optimize separation efficiency of the system 100. For example, the vortex finder 106 can be positioned along the tubular housing 104 at an optimized location to maximize the separation efficiency to ensure that most or all of the heavy phase 208 is directed to the annulus 110 and to ensure that most or all of the light phase 210 is directed to the central channel 108. In some examples, the vortex finder 106 can have a back end 216 that can be opposite the front end 214. In some examples, a support structure can be coupled with the back end 216, or otherwise along a length of the vortex finder 106, to support and/or retain the vortex finder 106 within the tubular housing 104. The support structure may be porous or may otherwise define openings, such as between struts, to allow fluid passage to continue through and/or beyond the support structure.

The back end 216 of the vortex finder 106 can be coupled with a first outlet 218 that may be arranged to collect the light phase 210. For example, the first outlet 218 may be coupled with the inner diameter 310 of the vortex finder 106 and may extend past the vortex finder 106 and away from the swirl flow generator 102. The first outlet 218 can have a bend 220 that can direct the light phase 210 away from the tubular housing 104 for being extracted from the system 100. Additionally or alternatively, the back end 216 of the vortex finder 106 can be coupled with a second outlet 222 that can be arranged to collect the heavy phase 208. In some examples, the first outlet 218 can include a first valve 224a, and the second outlet 222 can include a second valve 224b. The first valve 224a and the second valve 224b can be used to selectively collect the light phase 210 and the heavy phase 208, respectively, and can also be used to control back-pressure in the system to prevent entrainment of a phase into an incorrect passage. In some examples, the first valve 224a and/or the second valve 224b can be manual valves or can be automatic valves that can actuate based at least in part on a quality of separation and/or flow of the separated phases within the tubular housing 104.

Referring back to FIG. 3, the tapered region 302 of the vortex finder 106 can be adjusted to optimize the separation control of the system 100. For example, the tapered region 302 can have an angle 320 that can be defined between a direction of an angled surface of the tapered region 302 of the vortex finder 106 and a normal line with respect to the body of the vortex finder 106. The angle 320 may be angle α, and adjusting angle α can control stability of the heavy phase 208 and agglomeration of the light phase 210. In some examples, angle α can be optimized to maximize stability of the separated phases in the tubular housing 104 and to maximize separation of the separated phases from one another.

In some examples, such as examples in which the light phase 210 is stable, the light phase 210 may have a quasi-constant diameter 322. The front end 214 of the vortex finder 106 can have a hollow tapered-shape, for example corresponding to the tapered region 302, and the hollow tapered-shape can be adjusted via the angle α. The inclination of the tapered region 302 can be used as an obstacle for preventing the heavy phase 208 from approaching the central channel 108 and accidentally mixing with the light phase 210. Additionally or alternatively, the annulus 110 can generate a back-pressure that can be used, for example via the first valve 224a and/or the second valve 224b, to prevent the light phase 210 from approaching the annulus 110. In some examples, such as examples in which the light phase 210 is stable, the radial velocity is approximately zero, and the principal of radial equilibrium can be applied based on Equation 1, produced below.

$$\frac{\partial p}{\partial r} = \frac{{ρω}^{2}}{r} \qquad ( Equation 1 )$$

In Equation 1, p is the static pressure, ρ is the density, w is the tangential velocity, and r is the distance from a central axis.

In one example, the input material may have an approximately 50/50 distribution of light phase and heavy phase, a tangential velocity of

$$ω = 18 \frac{m}{s} ,$$

and a swirl number of S≃1.8. The swirl number can be the ratio of the axial flux of angular momentum to the axial flux of axial momentum defined by Equation 2, which is produced below.

$$S = \frac{\int r ω \vec{v} d \vec{A}}{R \int u \vec{v} d \vec{A}} \qquad ( Equation 2 )$$

In Equation 2, r is the distance from the axis, R is the pipe radius, u is the axial velocity component, ω is the tangential velocity component, and A is the area. Additionally or alternatively, the angle of inclination, for example the difference in directions between the tubular housing and a normal line of the inlet of the swirl vortex generator, can be approximately 10° (e.g., which may correspond to 80° for the angle 206 shown in FIG. 2). Based on the above parameters for the example, a film of the heavy phase can form on the tapered region of the vortex finder, and the film can be pushed back by the centrifugal effect of the system and the inclination effect of the vortex finder. Additionally or alternatively, the example may experience near perfect separation of light phase from heavy phase. Other suitable examples, and associated parameters, are possible for the system 100.

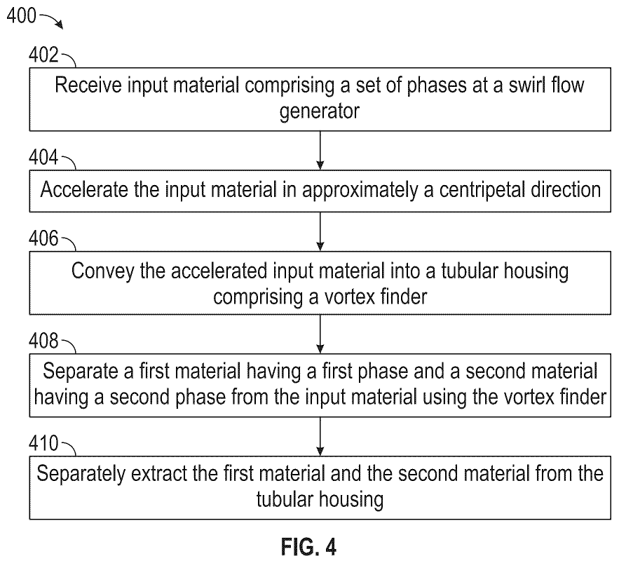

FIG. 4 is a flowchart of a process to separate phases of an input using a system 100 including a swirl flow generator 102 and a tubular housing 104 having a vortex finder 106 according to certain aspects of the present disclosure. At block 402, input material is received at a swirl flow generator 102 of a system 100, which may be or include a separator system such as a centrifugal separator system. The input material can include multiple phases; for example, the input material can include a light phase and a heavy phase. In some examples, the light phase can include gaseous material, such as natural gas or air, and the heavy phase can include liquid material such as oil or water. In other examples, the light phase can include lighter liquids, such as water, and the heavy phase can include heavier liquids such as oil. The input material can be received at the swirl flow generator 102 via the inlet 118.

At block 404, the input material can be accelerated in approximately a centripetal direction. In some examples, the input material can be accelerated in approximately the centripetal direction within the swirl flow generator 102. The swirl flow generator 102 can include tangential inlets 122 that can cause the input material to enter the internal cylindrical chamber 124 at a predetermined angle. The internal cylindrical chamber 124 can be used to cause the input material to accelerate in approximately the centripetal direction.

At block 406, the input material is conveyed into the tubular housing 104 to be separated into multiple phases. One or more valves, such as inlet valve 250, connecting the swirl flow generator 102, such as via the internal cylindrical chamber 124, with the tubular housing 104 can be used to convey the input material to the tubular housing 104. For example, and in response to determining that the input material has a sufficient tangential velocity, the one or more valves can open to allow the accelerated input material to be conveyed into the tubular housing 104.

At block 408, a first component of the input material is separated from a second component of the input material. In some examples, the first component may be or include the heavy phase, and the second component may be or include the light phase. Centripetally accelerating the input material may cause the input material to experience a centrifugal force, for example in a rotational reference frame. The centrifugal force can cause the heavy phase to separate from the light phase. For example, the centrifugal force may cause the heavy phase to migrate to larger radii, such as closer to a wall of the tubular housing 104, within the tubular housing 104 due to the heavier nature of the heavy phase, while the light phase may be retained at smaller radii such as closer to a central axis of the tubular housing 104. The vortex finder 106 may be used to separate the heavy phase from the light phase. For example, the vortex finder 106 can have the tapered region 302 that can encourage the heavy phase to separate from the light phase. Encouraging the heavy phase to separate from the light phase can involve or be facilitated by an angle 320 of the tapered region 302 that can cause back-pressure in the system 100. The back-pressure can be controlled by one or more valves, such as the first valve 224a and/or the second valve 224b, located at outlets in the system 100.

At block 410, the heavy phase and the light phase are separately extracted from the system 100. For example, the light phase can be extracted or otherwise collected via a first outlet, such as via the first valve 224a, coupled with or extending from a central channel, such as the central channel 108, of the vortex finder 106. Additionally or alternatively, the heavy phase can be extracted or otherwise collected via a second outlet, such as via the second valve 224b, coupled with or extending from an annulus defined by an outer surface the vortex finder 106 with respect to an inner surface of the tubular housing 104.

In some examples, the system 100 can have multiple different control points for controlling separation of the input material into the separated phases. A first control point may be or include the swirl flow generator 102, which may be configured or otherwise used for determining a gas, or light, phase core size and stability. Additionally or alternatively, a second control point may be or include the vortex finder 106 that can be sized, shaped, positioned within the tubular housing 104, and/or otherwise suitably arranged for causing the separated phases to be stable and collected via the system 100. Additionally or alternatively, a third control point may be or include the first valve 224a and/or the second valve 224b, which can be used to control back-pressure to avoid entrainment within the system 100 and to enhance separation control within the system 100.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

What is claimed is:

1. A system comprising:
a swirl flow generator comprising an inlet channel that is orientable in a first direction to receive input material comprising a plurality of phases and to accelerate the input material in approximately a centripetal direction; and
a tubular housing couplable with the swirl flow generator to receive the input material from the swirl flow generator, the tubular housing orientable in a second direction that is different than the first direction, the tubular housing comprising a vortex finder positionable along a length of the tubular housing and configured to separate the plurality of phases into separated phases.

2. The system of claim 1, wherein the swirl flow generator further comprises an annular chamber coupled with the inlet channel, and wherein the annular chamber comprises a set of tangential inlets oriented to cause the input material to accelerate in approximately the centripetal direction.

3. The system of claim 2, wherein the swirl flow generator further comprises an internal chamber positioned concentrically within the annular chamber, and wherein the set of tangential inlets are oriented to direct the input material from the annular chamber to the internal chamber while the input material accelerates in approximately the centripetal direction.

4. The system of claim 1, wherein the tubular housing extends beyond a predetermined length that is approximately equal to or less than a distance over which the separated phases are stable.

5. The system of claim 1, wherein a first end of the vortex finder is positioned within the tubular housing at a predetermined length, wherein a first diameter of the vortex finder is present at the first end, and wherein the vortex finder comprises a tapered region extending from the first end to a point along a body of the vortex finder such that an outer diameter of the vortex finder increases from the first diameter to a second diameter along the tapered region.

6. The system of claim 5, wherein an inner diameter of the vortex finder is sized to receive a first phase of the separated phases, wherein the second diameter is sized to receive a second phase of the separated phases, and wherein the first phase is different than the second phase.

7. The system of claim 1, wherein the plurality of phases comprises a first phase and a second phase, wherein the first phase is a light phase comprising gas or a first liquid, wherein the second phase is a heavy phase comprising a second liquid, wherein the first phase is extractable from the system via an inner channel of the vortex finder, and wherein the second phase is extractable from the system via an annulus around a body of the vortex finder.

8. The system of claim 1, wherein the first direction and the second direction are at an angle with respect to one another, and wherein the angle is from more than 0° to less than or equal to 180°.

9. A system comprising:
a tubular housing defining a flow channel configured for receiving input material that originates from a swirl flow generator and comprises a plurality of phases, the tubular housing couplable with the swirl flow generator; and
a vortex finder comprising an inner channel and a tapered region, the vortex finder positionable along a length of the tubular housing to define an annular channel between an outer surface of a body of the vortex finder and an inner wall of the tubular housing and to separate the plurality of phases into separated phases via the inner channel and the annular channel.

10. The system of claim 9, wherein the tubular housing has a predetermined length that is approximately equal to or less than a distance over which the separated phases are stable.

11. The system of claim 10, wherein a first end of the vortex finder is positioned within the tubular housing at the predetermined length, wherein a first diameter of the vortex finder is present at the first end, and wherein the tapered region extends from the first end to a point along the body such that an outer diameter of the vortex finder increases from the first diameter to a second diameter along the tapered region.

12. The system of claim 11, wherein an inner diameter of the vortex finder is sized to receive a first phase of the separated phases, wherein the second diameter is sized to receive a second phase of the separated phases, and wherein the first phase is different than the second phase.

13. The system of claim 9, further comprising the swirl flow generator comprising an inlet channel, wherein the tubular housing is oriented in a first direction that is different than a second direction defined by the inlet channel.

14. The system of claim 13, wherein the swirl flow generator further comprises:
an annular chamber coupled with the inlet channel, wherein the annular chamber comprises a set of tangential inlets oriented to cause the input material to accelerate in approximately a centripetal direction; and
an internal chamber positioned concentrically within the annular chamber, and wherein the set of tangential inlets are oriented to direct the input material from the annular chamber to the internal chamber while the input material accelerates in approximately the centripetal direction.

15. The system of claim 13, wherein the plurality of phases comprises a first phase and a second phase, wherein the first phase is a light phase comprising gas or a first liquid, wherein the second phase is a heavy phase comprising a second liquid, wherein the first phase is extractable from the system via an inner channel of the vortex finder, wherein the second phase is extractable from the system via an annulus of the vortex finder, wherein the first direction and the second direction are at an angle with respect to one another, and wherein the angle is from more than 0° to less than or equal to 180°.

16. A system comprising a swirl flow generator comprising:
an inlet channel orientable in a first direction to receive input material that comprises a plurality of phases; and
a swirl chamber couplable with the inlet channel to receive the plurality of phases and to accelerate the input material in approximately a centripetal direction and toward a tubular housing that is orientable in a second direction that is different than the first direction, the tubular housing comprising a vortex finder that is usable to separate the plurality of phases into separated phases.

17. The system of claim 16, wherein the swirl flow generator further comprises:
an annular chamber coupled with the inlet channel, wherein the annular chamber comprises a set of tangential inlets oriented to cause the input material to accelerate in approximately the centripetal direction; and
an internal chamber positioned radially inward from the annular chamber, and wherein the set of tangential inlets are oriented to direct the input material from the annular chamber to the internal chamber while the input material accelerates in approximately the centripetal direction.

18. The system of claim 16, wherein the plurality of phases comprises a first phase and a second phase, wherein the first phase is a light phase comprising gas or a first liquid, wherein the second phase is a heavy phase comprising a second liquid, wherein the first phase is extractable from the system via an inner channel of the vortex finder, wherein the second phase is extractable from the system via an annulus of the vortex finder, wherein the first direction and the second direction are at an angle with respect to one another, and wherein the angle is from more than 0° to less than or equal to 180°.

19. The system of claim 16, further comprising the tubular housing, and wherein the tubular housing extends beyond a predetermined length that is approximately equal to or less than a distance over which the separated phases are stable.

20. The system of claim 19, wherein a first end of the vortex finder is positioned within the tubular housing at the predetermined length, wherein a first diameter of the vortex finder is present at the first end, wherein the vortex finder comprises a tapered region extending from the first end to a point along a body of the vortex finder such that an outer diameter of the vortex finder increases from the first diameter to a second diameter along the tapered region, wherein an inner diameter of the vortex finder is sized to receive a first phase of the separated phases, wherein the second diameter is sized to receive a second phase of the separated phases, and wherein the first phase is different than the second phase.
